(19) United States
(12) Patent Application Publication
(10) Pub. No.: US 2014/0313556 A1
(43) Pub. Date: Oct. 23, 2014

(54) PORTABLE AUGMENTED VISION DEVICE

(71) Applicant: LASTER, Les Ulis Cedex (FR)

(72) Inventor: Zile Liu, Evry (FR)

(73) Assignee: LASTER, Les Ulis Cedex (FR)

(21) Appl. No.: 14/356,644

(22) PCT Filed: Nov. 6, 2012
(86) PCT No.: PCT/FR2012/052559

§ 371 Date: May 7, 2014

(30) Foreign Application Priority Data
Nov. 7, 2011 (FR) 1160125

(51) Int. Cl. G02B 27/01

(52) U.S. Cl. CPC G02B 27/0172; G02B 27/0176; G02B 2027/0174; G02B 2027/0178
USPC 359/13

(57) ABSTRACT

An optical unit (1) for augmented vision and augmented reality, which is to be placed in front of an eye of a user of the unit, includes a transparent or semitransparent screen (3), preferably a P-LED or TO-LED screen, and a unit (4) for collimating an image emitted by the screen toward the eye of the user, the collimating unit being a DOE, preferably an HOE, and the convergence function of the collimating unit being effective at a wavelength (FS) emitted by the screen.

The present invention relates to an augmented reality device, in particular called “optical see-through”, which may assume the form of glasses.

Augmented vision or reality systems allow users to view information that is superimposed on the actual environment they are currently observing. This information may include text, 2D or 3D elements, fixed images or video. Some augmented reality devices are also called head up display (HUD) devices.

Augmented vision devices exist that may be worn by the user, for example assuming the form of glasses or helmets. These wearable devices may be classified in four categories, depending on their architecture: front display devices, rear display devices, video see-through devices directly projecting the view through one or more cameras.

In front display devices, a single screen and eyepiece are placed directly in front of the user's eyes, obstructing his field of vision, such that part of the actual environment is concealed. Such a device is therefore poorly suited to augmented reality.

In rear display devices, a projector projects the information on a semi-transparent glass (also called a semi-reflective mirror) placed in the field of vision. Thus, the field of vision is not obstructed. Generally, there is a projector positioned on the top or on each side of the user's head. The projectors and their optics, which must be associated, are bulky and heavy.

The “video see-through” devices are an improvement of the front display devices. A screen and a front eyepiece are positioned in front of the user's eyes. A camera films the actual environment live, which is transmitted and reproduced on the screen, at the same time as the information that may be superimposed thereon through an augmented reality software engine. Such a device allows the user to perform augmented reality functions, but he sees the actual environment he is observing through cameras whose field of vision is much smaller than natural vision. Furthermore, details of the real environment can be deteriorated due to the optical quality of the cameras used, the resolution of which is often less than that of the human eye. Likewise, colors may sometimes be altered by the cameras or the front display system and the assembly does not always provide a color rendering of the environment that is faithful to the natural perception of the human eye when viewing it directly.

The invention aims to propose a device with a simplified design and usage method, as well as a reduced bulk and weight, while resolving all or part of the problems raised by the devices of the prior art.

In the description, the front and rear are defined assuming that the user's gaze is facing toward the front.

To achieve its aim, the invention proposes an optical augmented vision and reality assembly, designed to be placed in front of an eye of a user of that assembly, characterized in that it comprises: a screen of a transparent or semi-transparent type, preferably P-LED or TO-LED, and means for collimating an image emitted by the screen toward the user's eye, the collimating means being of the DOE (Diffractive Optical Elements) or HOE (Holographic Optical Elements) type, the convergence function of the collimating means being effective at a wavelength (FS) emitted by the screen.

The optical assembly may comprise a support, preferably optically neutral, in terms of power, behind which the screen is fastened. It may also not be neutral in the event of integration of a particular ophthalmic correction. Advantageously, a front face of the support comprises an optical treatment (for example, of the dielectric type) or an optic of the DOE or HOE type, the purpose of which is to block or divert the outside light corresponding to the wavelengths emitted by the screen so that they do not pass through the transparent or semi-transparent screen. The rear face comprises an optic of the DOE or HOE type that creates a virtual image of the transparent screen at a fixed or adjustable distance comprised between the “punctumproximum” and the “punctumremotum” of the user (in most cases, we prefer an infinity collimation of the pixels on the screen for better viewing comfort in the case of a user who is emmetropic or wears an ophthalmic correction).

The optical assembly may comprise a corrective glass, preferably positioned in front of or behind the collimating means.

The screen can comprise a convex, concave or free-form matrix. A screen in particular with a concave shape will make it possible to decrease part of the optical aberrations if it is followed by and effectively coupled to an optic of the DOE or HOE type. Likewise, the component elements of the optical assembly may have contact surfaces with each other that are planar, bent, concave or convex.

An augmented reality device according to the invention is characterized in that it comprises an augmented vision system according to the invention, and means for fastening that assembly to the user's head. The device may comprise two augmented vision assemblies, each across from a respective eye of the user. In such a device, the fastening means can comprise a spectacle frame, a helmet or a mask. The fastening means may comprise sensors, in particular head position sensors, an accelerometer, a gyroscope, a compass, a camera and/or a geolocation device. The fastening means may also comprise means for detecting the position of the pupil of the eye in front of which an optical assembly according to the invention is placed.

Several embodiments of the invention will be described below, as non-limiting examples, in reference to the appended drawings, in which:

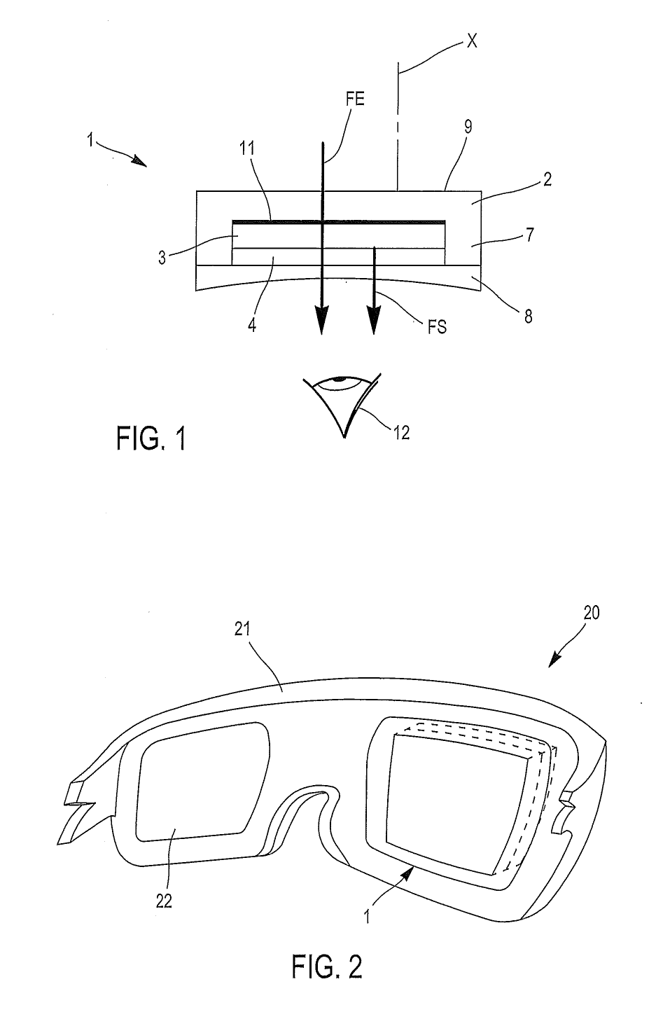

FIG. 1 is a diagrammatic cross-sectional view along the optical axis of an optical assembly according to the invention, and

FIG. 2 illustrates a pair of glasses comprising an optical assembly according to the invention.

FIG. 1 is a diagrammatic illustration of an optical assembly 1 comprising, from front to back, along an optical axis X: a support 2 that is substantially optically neutral, a screen that is substantially transparent 3, a diffractive optical element (DOE) or a holographic optical element 4 (HOE).

In the illustrated example, the support 2 is in the shape of a square basin, concave toward the rear, having a flat bottom and a peripheral edge 7 that is raised toward the rear. A sub-assembly 3, 4 formed by the screen and the DOE is housed in the basin, such that the DOE is flush with the edge 7 of the support 2.

In the illustrated example, the optical assembly 1 further comprises an ophthalmic glass 8 positioned bearing against a surface formed by the DOE and the edge 7.

The screen 3 is substantially flat and has a substantially constant thickness; it comprises a TFT matrix 11 positioned in contact with the support 2, at the bottom of the basin. For example, the screen may be of the P-LED (Polymer—Light Emitting Diode) type, or of the TO-LED (Transparent Organic—Light Emitting Diode) type. Advantageously, the pixels can comprise titanium dioxide.

The screen is positioned in a focus of the DOE 4. Preferably, the DOE 4 is of the HOE (Holographic Optical Element) type. Advantageously, the front face 9 of the support 2 is treated with a multilayer dielectric treatment. The purpose of the DOE is to collimate the light beams FS from the screen 3 toward the user's eye 12. The DOE thus synthesizes the function of an optic that may be reduced in a simple embodiment with one converging lens whereof the focus would be placed at the screen 3.

Preferably, the dielectric treatment on the front face 9 comprises means for filtering the outside light. It is positioned on the outer face of the support, on the environment side, and is used to block the outside light FE corresponding to the wavelength of the monochromatic light emitted by the screen 3, if it is monochromatic, i.e., the light whereof the wavelength corresponds to the wavelength FS of the screen 3, for which the HOE 4 was designed. In the case of a polychromatic screen, generally combining 3 or 4 specific wavelengths, each wavelength used by the screen may be treated in the same way as described above, using the dielectric treatment blocking or diverting those wavelengths, coming from the environment, so that they do not cross through the HOE 4.

The ophthalmic glass is provided to correct the user's vision of the actual environment, i.e., that which is located in front of the optical assembly, as done by the corrective lenses of simple eyeglasses.

As illustrated in FIG. 2, in an augmented vision device 20 according to the invention, the optical assembly 1 is advantageously integrated into means 21 for keeping it fastened to the user's head. In the illustrated example, the fastening means are a frame 21 of the spectacle frame type. In the illustrated example, only one assembly 1 is supported by the frame. Thus, an optical assembly according to the invention may be provided across from only one of the user's eyes, for example the dominant eye, a neutral glass 22 for example being provided across from the other eye. It may also be provided that a respective optical assembly is provided across from each of the two eyes, the device according to the invention then being of the binocular or stereoscopic type.

Of course, the invention is not limited to the preferred embodiments described above, but on the contrary, the invention is defined by the following claims.

One skilled in the art will in fact see that various changes may be made to the embodiments described above, in light of the teaching disclosed to him above.

Thus, in particular, a device according to the invention may assume the form of a helmet rather than a pair of glasses.

The screen has been shown substantially planar. On the contrary, in particular at the matrix 11, it may be provided to be curved, preferably concave toward the rear.

1. An optic assembly (1) for augmented vision and reality, intended to be placed in front of an eye (12) of a user of said assembly, characterized in that it comprises a screen (3) of a transparent or semi-transparent type, preferably of the P-LED or TO-LED type, and means (4) for collimating an image emitted by said screen toward said eye of the user, said collimator means being of the DOE type, preferably of the HOE type, the convergence function of said collimator means being effective at a wavelength (FS) emitted by the screen.

2. The assembly according to claim 1, characterized in that it comprises an optically neutral support (2) behind which the screen (3) is fastened.

3. The assembly according to claim 2, characterized in that a front face (9) of the support (2) comprises an optical treatment of the dielectric type, of the HOE or DOE type serving to block or divert the outside light (FE) corresponding to the wavelength (FS) emitted by the screen.

4. The assembly according to claim 1, characterized in that it comprises a corrective lens (8), positioned in front of or behind the collimator means (4).

5. The assembly according to claim 1, characterized in that the screen (3) comprises a convex, concave or free-form matrix (11) of pixels, preferably concave.

6. An augmented reality device (20), characterized in that it comprises an optical augmented vision assembly (1) according to claim 1, and means (21) for fastening said assembly to a user's head.

7. The device (20) according to claim 6, characterized in that it comprises two augmented vision assemblies, each of said assemblies being positioned across from a respective eye of the user.

8. The device according to claim 6, characterized in that the fastening means comprise a spectacle frame (21).

9. The device according to claim 6, characterized in that the fastening means comprise one or more sensors, preferably head position sensors and/or geolocation sensors.

10. The device according to claim 6, characterized in that the fastening means comprise means for detecting a position of the pupil of the eye.

11. The assembly according to claim 2, characterized in that it comprises a corrective lens (8), positioned in front of or behind the collimator means (4).

12. The assembly according to claim 2, characterized in that the screen (3) comprises a convex, concave or free-form matrix (11) of pixels, preferably concave.

13. An augmented reality device (20), characterized in that it comprises an optical augmented vision assembly (1) according to claim 2, and means (21) for fastening said assembly to a user's head.

14. The device according to claim 7, characterized in that the fastening means comprise a spectacle frame (21).

15. The device according to claim 7, characterized in that the fastening means comprise one or more sensors, preferably head position sensors and/or geolocation sensors.

16. The device according to claim 7, characterized in that the fastening means comprise means for detecting a position of the pupil of the eye.
